(19) United States
(12) Patent Application Publication
(10) Pub. No.: US 2006/0198598 A1
(43) Pub. Date: Sep. 7, 2006

(54) Light-guide plate

(75) Inventors: Chong-Yang Fang, Tainan County (TW); Ping-Yeng Chen, Taichung County (TW); Kuo-Jui Huang, Taichung County (TW)

Correspondence Address: BIRCH STEWART KOLASCH & BIRCH, PO BOX 747, FALLS CHURCH, VA, 22040-0747, US

(73) Assignee: WINTEK CORPORATION

(21) Appl. No.: 11/363,324

(22) Filed: Feb. 28, 2006

(30) Foreign Application Priority Data
Mar. 1, 2005 (TW) 094105975

(51) Int. Cl. G02B 6/10; F21V 8/00

(52) U.S. Cl. 385/146; 362/615

(57) ABSTRACT

A light-guide plate and its light-guide structures that are formed at the plate body of the light-guide plate in a concave configuration, a bottom side of the light-guide facet of the light-guide structures that face to the light source approximately presents an arc-like shape. The arc-like shape makes the light after deflecting have the effect of diffusion for a certain extent. These light-guide structures present a sparse-to-dense distribution along the direction that is away from the light source. The arc angles of the bottom side of the light-guide structures present a large-to-small configuration along the direction that is away from the light source such that the whole brightness of the light-guide plate is uniform.

### FIELD OF THE INVENTION

The present invention relates to a light-guide plate and aims to make a change of the light-guide structure inside the light-guide plate such that the deflected light has the effect of diffusion for a certain extent and the directional characteristic so as to let the light-guide plate emit light uniformly.

### BACKGROUND OF THE INVENTION

Please refer to FIG. 1. The light from the light source 3 is reflected or refracted by the light-guide structure 2 and emitted outward from the light guide for conventional light-guide plate. The merit of this light-guiding mechanism is that the light deflected by the light-guide structure 2 has a strong directionality. Because the angle between the deflected light and the normal direction of the emitting facet of the light-guide plate become lower via reflection or refraction, the limitation of the total reflection is broken and the light can be deflected out of the light-guide plate 1. Moreover, the light can be guided and concentrated to a specific direction according to the design of the structure. As a result, the light-emitting distribution of the light-guide plate 1 is concentrated.

The prism 4 can guide the light emitted from the light-guide plate to the direction which is vertical to the light-emitted surface of the guide-light plate. At this time, most of light will be gathered in the normal direction and the brightness of this light-guide plate is much brighter than the general light-guide plate which has diffuse light-emitted distribution. However, the light-guide structure of this design method will make the deflected light from the light-guide plate to be concentrated in a narrow area, and the deflected light beam is concentrated (as shown in FIG. 2) such that a drawback of smaller view angle is resulted. Moreover, adjusting the uniformity of emitting light for the light-guide plate 1 becomes difficult. Generally, the method for solving this problem is to place a diffuser above the prism 4 so as to diffuse the light beam. Although using a diffuser can solve the problem mentioned above, the light-diffusion capability of the diffuser is still difficult to control. Controlling the light diffused by a diffuser in a certain range of angle is very hard. And the brightness of the backlight in the normal direction will reduce sharply if the light distribution is more diffuse. Besides, the diffuser itself has the function of reflecting and diffusing such that a part of the incident light is reflected and diffused, hence the whole brightness of the backlight module is degraded substantially.

The existing light-guide structure 2 has many different shapes, and the light-guide efficiency of each shape of the light-guide structure 2 is different from each other. Generally speaking, the rectangular light-guide structure 2 with the long side that is perpendicular to the direction along the line connecting the light-guide structure 2 and the light source has higher light-guide efficiency. Accordingly, most of the light-guide structures 2 for the high-luminance light-guide plate 1 are rectangular.

After lighting the backlight with rectangular light-guide structure 2, the light spots appear on the backlight, especially in the area where the density of the structures is lower. The reason for the light spots appearing is that the light deflected by the rectangular structures is focused in a narrow range and can't cover the zone which is around the structure and no light is emitted from. The current methods for solving the problem are to reduce the size of the light-guide structures 2 and to shorten the distance between each light-guide structure 2 so as to adjust the uniformity and to eliminate light spots.

Moreover, because the light-guide structure 2 is done mostly by the photo-lithography, if we adjust the brightness uniformity and eliminate light spots by shortening the distance between light-guide structures 2 and reducing the sizes of the light-guide structures 2, it becomes necessary to reduce the sizes of the holes on the mask corresponding to the light-guide structure 2 and to shorten the distance between each hole. However, the closer the distance between each hole on the mask, the easier the diffraction occurs in the exposing process such that the photo-resist deforms and then the light-guide structure 2 on the produced light-guide plate 1 deforms. To avoid this, it is necessary to use the exposing equipment that has the light source with shorter wavelengths for exposing and masks and photo-resists with smaller line-width. As a result, the cost of the manufacturing process rises substantially. Besides, during the injection-molding process for the light-guide plate 1, the too small and too dense light-guide structure 2 results in ill forming such that the qualities of produced light-guide plates 1 are unstable.

### SUMMARY OF THE INVENTION

Consequently, for solving the abovementioned problems, the present invention proposes the light-guide facet of the light-guide structure presenting an arc-surface configuration which lets the deflected light keep the directional characteristic and have the effect of light-diffusion for a certain extent at the same time. By way of this, the drawback of narrow emitting angle due to the too high directional characteristic for the well-known light-guide structures can be mended. Hence, the light guide plate does not need to use a diffuser or only needs to use a diffuser with lower haze. The brightness of the backlight module is further upgraded at the same time.

The next purpose of the present invention is to adjust the brightness uniformity of the light-guide plate via changing the light-guide efficiency of the light-guide structure. Adopt the light-guide structure with higher light-guide efficiency in the zone with higher luminous flux in the light-guide plate. Adopt the light-guide structure with lower light-guide efficiency in the zone with lower luminous flux in the light-guide plate. Besides, adjust the distribution density of the light-guide structures based on the distance between the light source and the light-guide structure. Therefore, it is easier to adjust the brightness uniform of the light-guide plate.

The final purpose of the present invention is to reduce the manufacturing process difficulty via the light-guide structure with the effect of light diffusion for a certain extent. Due to the light-guide structure having a certain extent of light-emitted effect, the present invention will not need to adjust the brightness uniformity of the light-guide plate via shorting the distance between light-guide structures and diminish the light-guide structure size as known in the prior art. Therefore, the control for the manufacturing process becomes easier and the quality of the produced light-guide plate is more stable.

The present invention is a light-guide plate whose material is transparent and its light-guide structures. The light-guide plate is used in the backlight module that uses at least one light-emitting element as the light source. The light-guide plate includes one light-incident facet, one bottom facet and one light-output facet that are opposite to the bottom facet, and the plural light-guide structures that are formed at the plate body of the light-guide plate in a concave configuration, which can be on at least either one of the bottom facet or the light-output facet. The light-guide structures include one light-guide facet that faces to the light source and the bottom side of the light-guide facet presents an arc-like shape that makes the light deflected by the light-guide structure to have the effect of diffusion for a certain extent.

The layout characteristics for these light-guide structures of the light-guide plate are: these light-guide structures present a sparse-to-dense distribution along the direction that is away from the light source, and the arc angles of the bottom side of the light-guide facet of the light-guide structures present a large-to-small configuration along the direction that is away from the light source such that the light guide efficiency of the light guide structures is low in the high luminous flux area and the light guide efficiency of the light-guide structures is high in the low luminous flux area. The light-guide plate can have higher brightness uniform and light-guide effect at the same time by this way.

### BRIEF DESCRIPTION FOR THE DRAWINGS

FIG. 1 is a schematic diagram for the structure of a well-known backlight module.

FIG. 2 is a schematic diagram for the light deflection of a well-known light-guide structure.

FIG. 3 is a schematic diagram for a well-known light-guide structure.

FIG. 4 is a schematic diagram showing a light-guide plate having light-guide structures of the present invention.

FIG. 5 is an enlarged schematic diagram showing a first preferred light-guide structure of the present invention.

FIG. 6 is an enlarged schematic diagram of a second preferred light-guide structure of the present invention.

FIG. 7 is an enlarged schematic diagram of a third preferred light-guide structure of the present invention.

FIG. 8 is an enlarged schematic diagram of a fourth preferred light-guide structure of the present invention.

FIG. 9 is a first schematic diagram for the overlook of the light-guide structure.

FIG. 10 is a second schematic diagram for the overlook of the light-guide structure.

FIG. 11 is a third schematic diagram for the overlook of the light-guide structure.

FIG. 12 is a fourth schematic diagram for the overlook of the light-guide structure.

FIG. 13 is a fifth schematic diagram for the overlook of the light-guide structure.

FIG. 14 is a sixth schematic diagram for the overlook of the light-guide structure.

FIG. 15 is a seventh schematic diagram for the overlook of the light-guide structure.

FIG. 16 is an eighth schematic diagram for the overlook of the light-guide structure.

FIG. 17 is a schematic diagram for the light deflection of the light-guide structure of the present invention.

FIG. 18 is a coordinate diagram for the arc angle of the bottom side the light guide facet of the light guide structure vs. light-guide efficiency of the present invention.

FIG. 19 is a first schematic diagram for the layout on the light-guide plate for the light-guide structure of the present invention.

FIG. 20 is a second schematic diagram for the layout on the light-guide plate for the light-guide structure of the present invention.

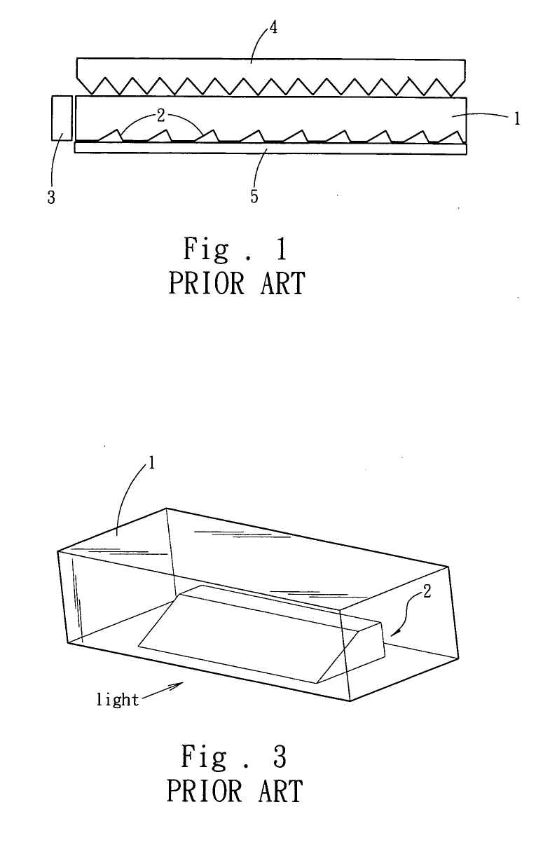

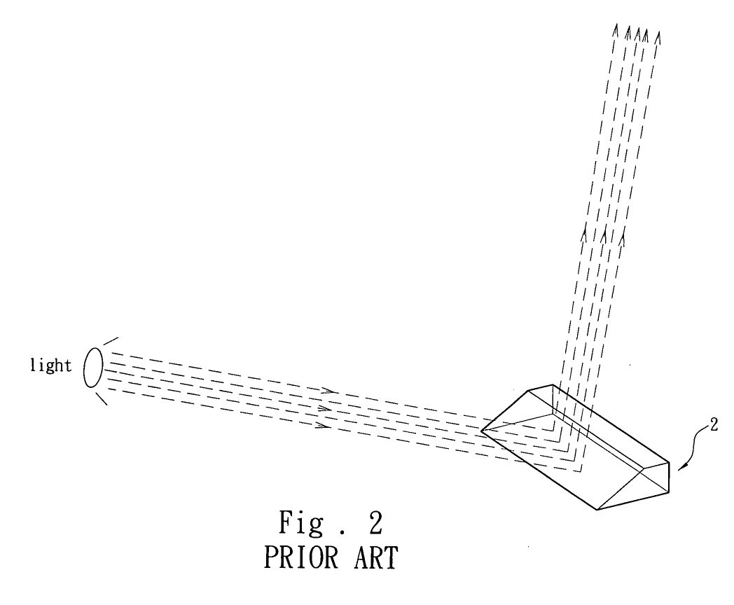

### DETAILED DESCRIPTION OF THE PREFERRED EMBODIMENTS

The detailed descriptions for content and technology of this invention associate with figures are as followings.

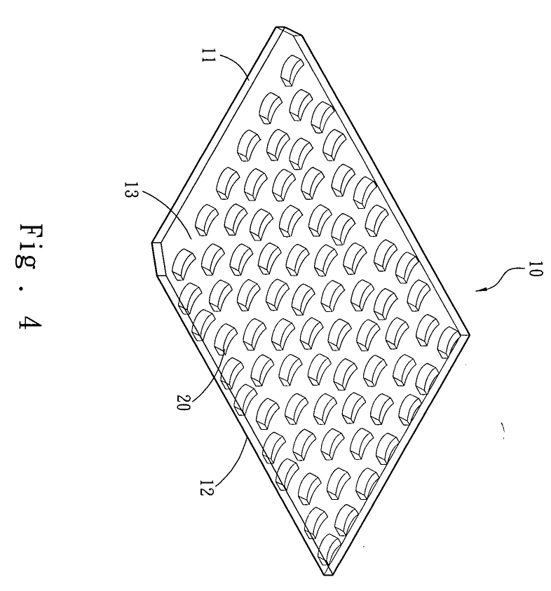

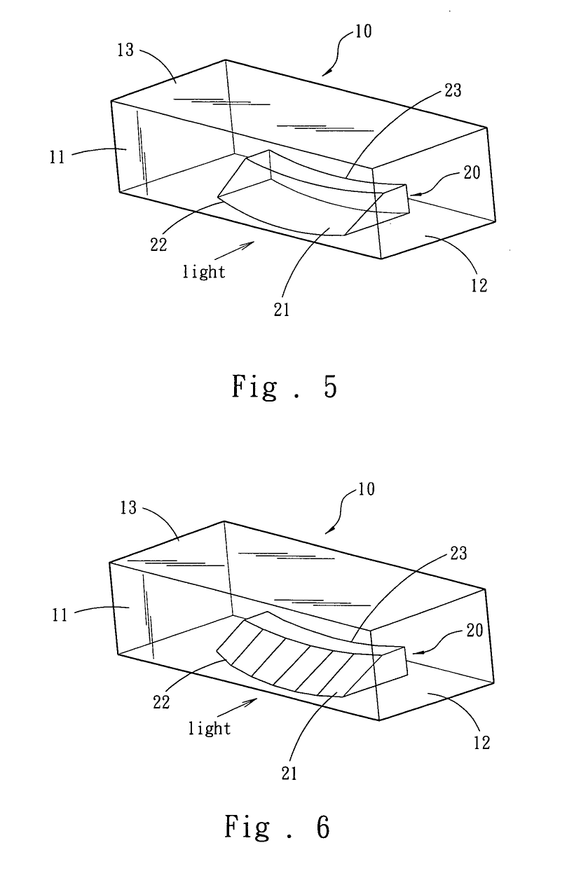

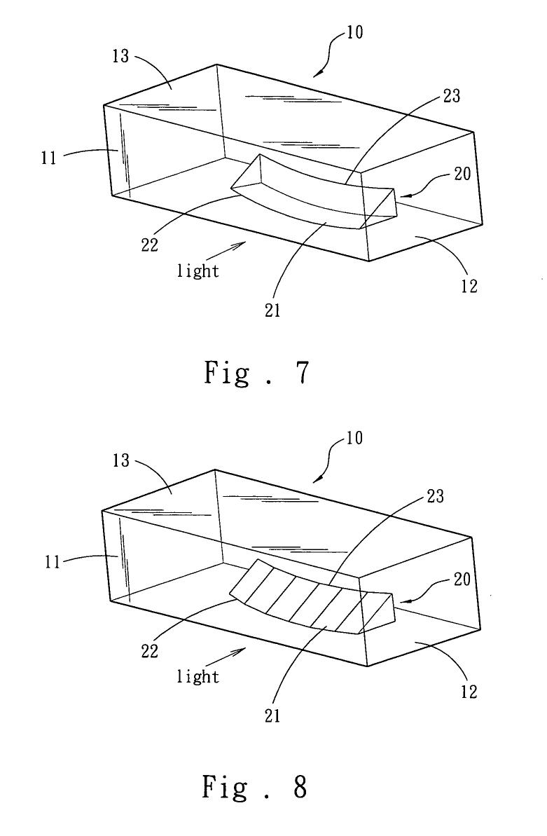

Please refer to FIGS. 4 and FIGS. 5. FIGS. 4 is an embodiment of a schematic diagram showing a light-guide plate having randomly arranged light-guide structures of the present invention. FIG. 5 is an enlarged schematic diagram showing a first preferred light-guide structure of the present invention. The present invention is related to a transparent light-guide plate 10 and arc shaped light-guide structures 20 thereon. The light-guide plate 10 is used in a backlight module that uses at least one light-emitting element as the light source. The light-guide plate 10 includes one light-incident facet 11, one bottom facet 12 extended from one side of the light-incident facet 11, one light-output facet 13 opposite to the bottom facet 12, and a plurality of light-guide structures 20 (the configuration shown in the FIG. 5 is only one single light-guide structure 20) formed on the light-guide plate 10 in a concave configuration. To be more specific, the light-guide structures 20 can be selectively formed on the bottom facet 12 or the light-output facet 13. Also, the light-guide structures 20 can be formed on both of the bottom facet 12 and the light-output facet 13. Each of the light-guide structures 20 includes one light-guide facet 21 that faces to the light source, and the bottom side 22 of the light-guide facet 21 presents an arc-like shape. In which the light-guide facet 21 can be a smooth surface (as shown in FIGS. 5 and 7) or a surface formed by plural polygons such that the bottom side 22 of the light-guide facet 21 presents an arc-like shape composed of multi-line segments (as shown in FIGS. 6 and 8).

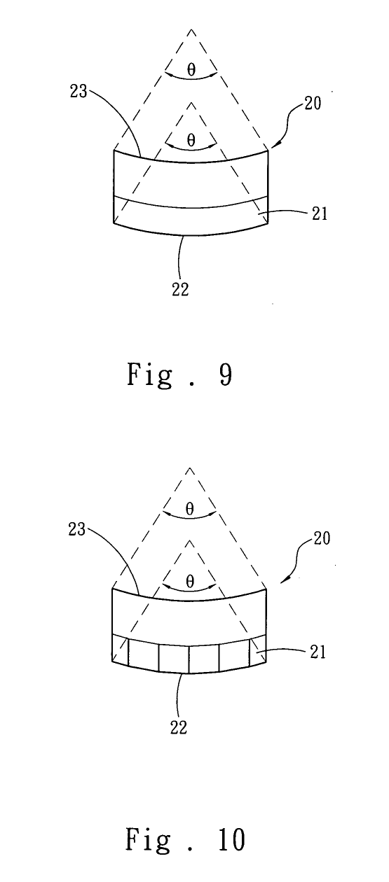

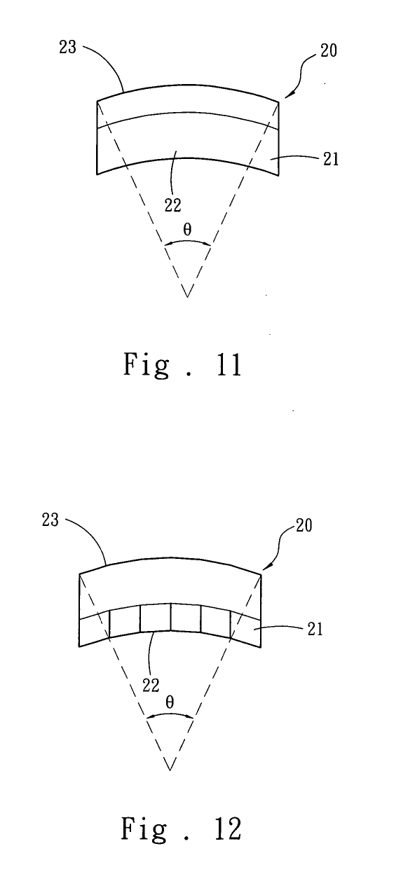

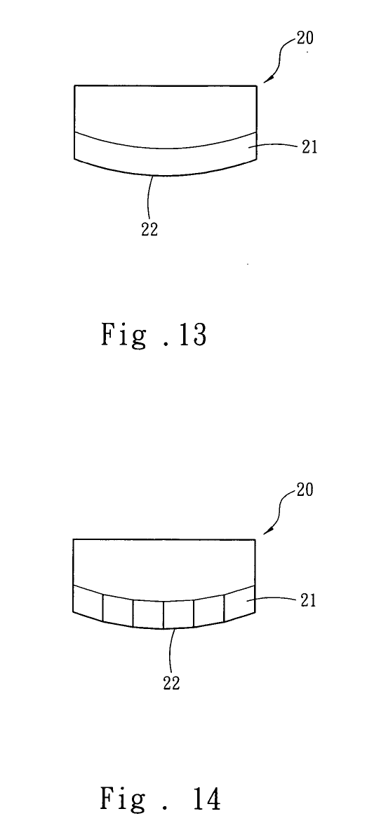

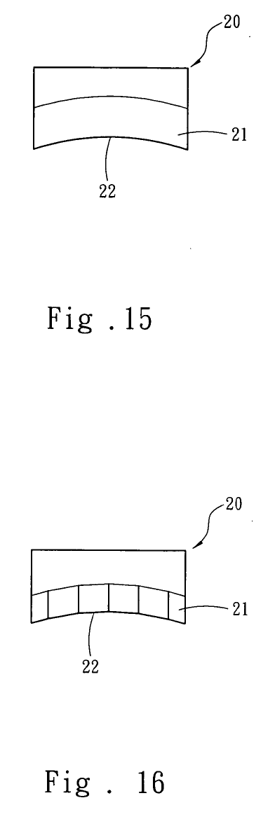

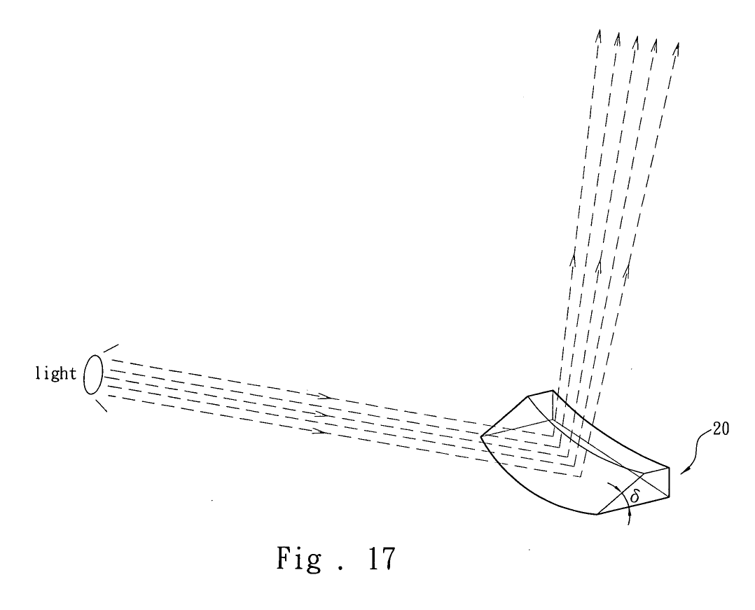

The included angles between the light-guide facet 21 and the bottom facet 12 of the light-guide plate 10 are in the range of 20° to 90°, and the arc angles of the bottom side 22 are in the range of 0°˜180°. In other words, the light-guide facet 21 is substantially in a rectangle shape when the arc angle of the bottom side 22 is extremely close to 0°. The light-guide facet 21 and its opposite facet 23 present an asymmetrical form, as shown in FIGS. 9 to 16. For example, each of the overlooked schematic diagrams in FIG. 9 to FIG. 12 illustrates that the opposite facet 23 is an arc surface with the same arc angle θ as the light-guide facet 21. In FIGS. 13 to FIG. 16, each of the overlooked schematic diagrams illustrates that the opposite facet 23 is close to a plane while the light-guide facet 21 is an arc surface.

Please refer to FIG. 17, which is the schematic diagram illustrating the light deflection effect of the light-guide structure of this invention. Because the bottom side 22 of the light-guide facet 21 is an arc-like shape and an included angle δ is formed by the light-guide facet 21 and the bottom facet 12, the light impinges on the light-guide structure 20 is deflected as well as diffused for a certain extent. The principle is that the arc-shape structure with different arc angles can control the diffusion extent of the light deflected by the light-guide structure 20. In other words, if the arc angle of light-guide facet 21 were lager, the light deflected by the light-guide facet 21 would result in higher diffusion extent. As a result, the light that outputs from light guide plate 10 has larger diffusion range as well as more uniformity.

The light-guide structure 20 with the arc-shape light-guide facet 21 has the advantage of making deflected light diffuse in a certain angle range so as to let the light emitted by the light-guide plate 10 be distributed more widely. As long as the light-guide structure 20 has the double capabilities of creating deflection effect and diffusion effect, it is no need to employ a diffuser or it only needs a diffuser with lower haze to slightly further diffuse the light emitted from the light-guide plate 10 in a backlight module. Therefore, the brightness of this backlight module is higher than the conventional one. Besides, in the front portion of the light-guide plate near the light source, the luminous flux is higher so that the light-guide structures are arranged in form of lower distribution density.

Assumed that the light-guide facet 21 is a rectangle flat surface, i.e. arc angles θ=0°, the light-guide facet 21 would have no capability of diffusing incident light. Based on the assumption, when we look at the light-output facet 13, the portion of light guide plate 10 with the light-guide structures 20 formed therein will be much brighter. Accordingly, we would see unneeded light spots from the view of the light-output facet 13.

In order to solve the problem mentioned above, we create the light-guide structure 20 with the arc-shape light-guide facet 21 to add the function of diffusing incident light for a certain extent after the incident light is deflected. Obviously, the present invention can effectively avoid the emergency of unneeded light spots and substantially improve the visual effect.

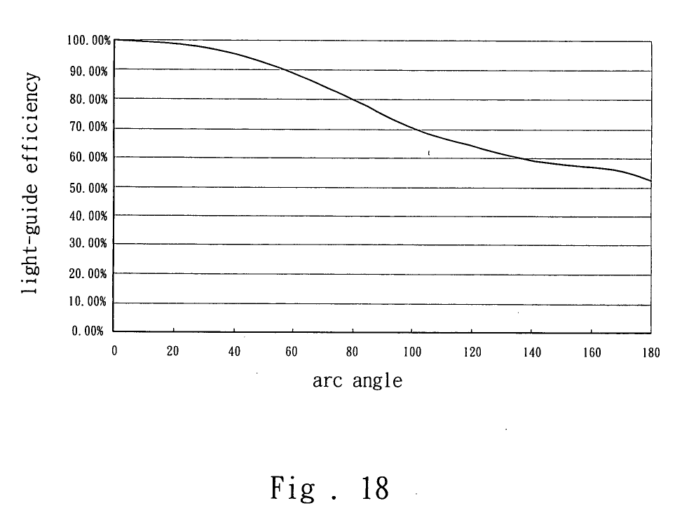

FIG. 18 illustrates an example of the relationship between the light-guide efficiency and the arc angle (for example, the arc angle θ shown in FIG. 9) of the light-guide facet 21. Each of the included angle (for example, the included angle δ shown in FIG. 17) between the light-guide facet 21 and the bottom facet 12 of the light-guide structures 20 is fixed in 20° and each of the arc angle θ of the bottom side 22 of the light-guide facet 21 is in the range of 0° to 180°. The light-guide efficiency L1/L2 is defined as—the luminous flux L1 (refracted or reflected out of the light-output facet 13 via the light-guide structures 20) divided by the luminous flux L2 (emitted from the light source and then entering the light-guide plate 10). Due to the diffusion effect, the larger arc angle (for example, the arc angle θ shown in FIG. 9) of the bottom side 22 leads to lower light-guide efficiency as a result.

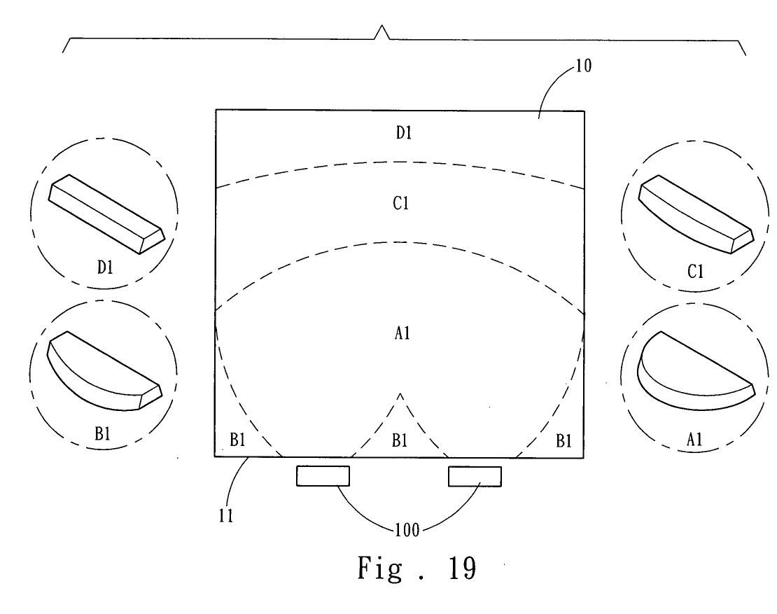

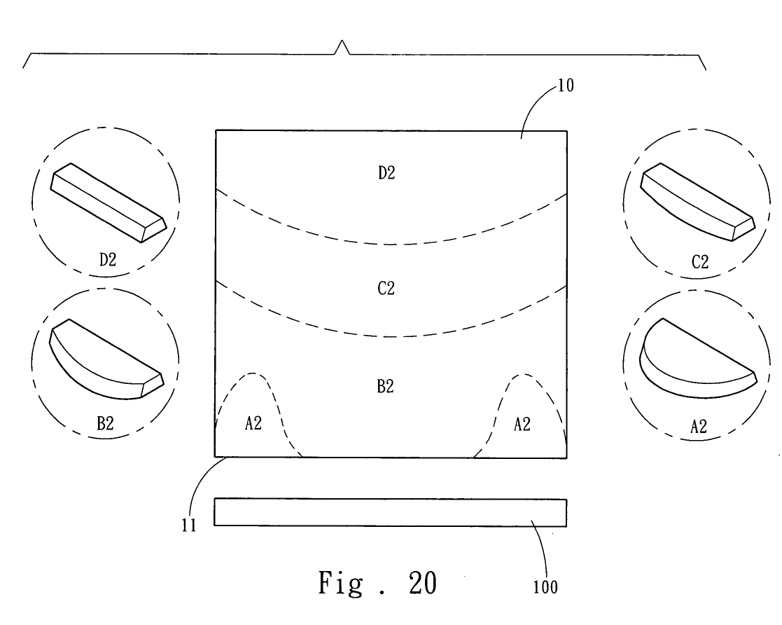

Please refer to FIGS. 19 and 20, at lease one light-emitting element 100 is provided adjacent to the light-incident facet 11 of the light-guide plate 10. The light-emitting element 100 can be a point light source such as LED (as shown in FIG. 19) or a linear light source such as CCFL (as shown in FIG. 20). The arrangement of the light-guide structures 20 on the light-guide plate 10 is that the spacing between the adjacent light-guide structures 20 narrows as the distance from the light-emitting element 100 increases. In other words, the distribution density of the light-guide structures 20 increases as the distance from the light-emitting element 100 to the light-guide structures 20 increases. Moreover, the arc angle of the bottom side of each light-guide structure 20 decreases as the distance from the light-emitting element 100 to the light-guide structures 20 increases. It is desired to do such arrangement mentioned above for the performance of uniform brightness because the light-guide structures 20 receive smaller luminous flux as the distance from the light-emitting element 100 to the light-guide structures 20 increases.

To be more specific, in the area (A1 shown in the FIG. 19 and A2 shown in the FIG. 20) closing to the light-emitting element 100 on the light-guide plate 10, the light-guide structures 20 approximate semicircle with the largest arc angle θ (for example, 180°). Further, the spacing between the adjacent light-guide structures 20 in this area (A1 or A2) is larger than those in other area (for example, B1, C1, D1 . . . ). As a result, such arrangement allows the light to impinge on the light-guide structures 20 provided in the area far away from the light source (for example, D1, D2 . . . ) through the larger spacing between adjacent light-guide structures provided in areas near the light-emitting element 100.

The light-guide efficiency of in the area next close to the light source (as the area B1 shown in the FIG. 19 and B2 shown in the FIG. 20) should be higher than the aforementioned one's and the arc angle is relatively smaller. Likewise, the light-guide efficiencies in C1 and C2 are in turn lower than those in B1 and B2, respectively. The light-guide efficiency in the area farthest from the light source should be the best, and the arc angle of the light-guide structures 20 in this area (for example, D1 or D2 shown in FIG. 19 and FIG. 20) is the smallest compared to those in other area. It is for sure that the distribution density of the light-guide structures 20 of this area is the highest. The design rule of this invention is to ensure low light-guide efficiency in the high luminous flux area (near the light source) and high light-guide efficiency in the low luminous flux area (away from the light source) so as to enhance the light uniformity and brightness of the light-guide plate 10.

To sum up, the light-guide structures 20 have a function of diffusing deflected light without losing the directional characteristic of deflected light. Therefore, the brightness of the backlight module is further enhanced without using a diffuser or only using a low haze diffuser.

Moreover, forming several kinds of light-guide structures 20 with different arc shape on the light guide plate 10 would result in corresponding light-guide efficiencies. In other words, the light-guide efficiency of the light-guide structures 20 will be lower in the high luminous flux area and the light-guide efficiency of the light-guide structures 20 will be higher in the low luminous flux area so as to uniform the brightness of the light-guide plate 10. Therefore, the configuration change of the light-guide structures 20 can control the effect of light-diffusion. It is not necessary to adjust the uniformity by reducing the size of the light-guide structures 20 and shortening the distance between each light-guide structure 20. As a result, the manufacturing process becomes easier to control and the quality of the light-guide plate is more stable.

However, the above description is only a better practice example for the current invention, which is not used to limit the practice scope of the invention. All equivalent changes and modifications based on the claimed items of this invention are in the scope of the present invention.

What is claimed is:

1. A light-guide structure formed on a light-guide plate, the light-guide plate having a light-incident facet facing a light source and a bottom facet extended from one end of the light-incident facet, the light-guide structure comprising:
a light-guide facet facing the light-incident facet, the light-guide facet being substantially smooth and a bottom side thereof presenting an arc-like shape; and
an opposite facet being asymmetrical against the light-guide facet.

2. The light-guide structure as claimed in claim 1, wherein the light-guide facet and the bottom facet form an included angle which is in the range of 20° to 90°.

3. The light-guide structure as claimed in claim 1, wherein the bottom side of the light-guide facet has an arc angle which is in the range of 0° to 180°.

4. A light-guide structure formed on the light-guide plate, the light-guide plate having a light-incident facet facing a light source and a bottom facet extended from one end of the light-incident facet, the light-guide structure comprising:
a light-guide facet formed by a plurality of polygon surfaces facing the light-incident facet, the light-guide facet having an arc-shaped bottom side having a plurality of linear segments; and
an opposite facet being asymmetrical against the light-guide facet.

5. The light-guide structure as claimed in claim 4, wherein the light-guide facet and the bottom facet form an included angle which is in the range of 20° to 90°.

6. The light-guide structure as claimed in claim 4, wherein the bottom side of the light-guide facet has an arc angle which is in the range of 0° to 180°.

7. A light-guide plate, which is used in a-backlight module having at least one light source, the light-guide plate comprising
a light-incident facet,
a bottom facet and an opposite light-output facet, the bottom facet and the light-output facet being extended from the two ends of the light-incident facet respectively; and
a plurality of light-guide structures being formed at least on one of the bottom facet and the light-output facet,
wherein each of the light-guide structures has an substantially smooth light-guide facet that faces the light source, an arc-like shaped bottom side of the light-guide facet, and an opposite facet being asymmetrical against the light-guide facet.

8. The light-guide plate as claimed in claim 7, wherein the material of the light-guide plate is transparent.

9. The light-guide plate as claimed in claim 7, wherein the light-guide structures are in a concave configuration.

10. The light-guide plate as claimed in claim 7, wherein the light-guide facet and the bottom facet forms an included angle which is in the range of 20° to 90°.

11. The light-guide plate as claimed in claim 7, wherein the bottom side of the light-guide facet has an arc angle which is in the range of 0° to 180°.

12. The light-guide plate as claimed in claim 7, wherein the light-guide structures of the light-guide plate present a sparse-to-dense distribution along the direction that is away from the light source.

13. The light-guide plate as claimed in claim 7, wherein the arc angles of the bottom side present a large-to-small configuration along the direction that is away from the light source.

14. A light-guide plate, which is used in the backlight module that equips at least one light source, including:
a light-incident facet;
a bottom facet and one light-output facet that are opposite to each other and extended from the two ends of the light-incident facet respectively; and
a plurality of light-guide structures being formed on at least one of the bottom facet and the light-output facet,
wherein each of the light-guide structure has one light-guide facet that faces to the light source and one opposite facet that presents an asymmetrical form to the light-guide facet, and the light-guide facet is arranged by plural polygon surfaces, and a bottom side of the light-guide facet presents an arc-like shape composed by multi-line segments.

15. The light-guide plate as claimed in claim 14, wherein the material of the light-guide plate is transparent.

16. The light-guide plate as claimed in claim 14, wherein the light-guide structures are in a concave configuration.

17. The light-guide plate as claimed in claim 14, wherein the light-guide facet of the light-guide structures and the bottom facet of the light-guide plate form an included angle which is in the range of 20° to 90°.

18. The light-guide plate as claimed in claim 14, wherein the bottom side of the light-guide structures has an arc angle which is in the range of 0° to 180°.

19. The light-guide plate as claimed in claim 14, wherein the light-guide structures of the light-guide plate present a sparse-to-dense distribution along the direction that is away from the light source.

20. The light-guide plate as claimed in claim 14, wherein the arc angles of the bottom side present a large-to-small configuration along the direction that is away from the light source.
